(19) United States
(12) Patent Application Publication
(10) Pub. No.: US 2009/0204536 A1
(43) Pub. Date: Aug. 13, 2009

(54) METHODS AND SYSTEMS FOR NETWORK LOAN MARKETING

(76) Inventor: Christopher KENNEDY, Lake Worth, FL (US)

Correspondence Address: ARENT FOX LLP, 1050 CONNECTICUT AVENUE, N.W., SUITE 400, WASHINGTON, DC, 20036, US

(21) Appl. No.: 12/334,168

(22) Filed: Dec. 12, 2008

Related U.S. Application Data
(63) Continuation-in-part of application No. 11/802,308, filed on May 22, 2007.
(60) Provisional application No. 60/996,949, filed on Dec. 12, 2007.
(60) Provisional application No. 60/996,975, filed on Dec. 13, 2007.
(60) Provisional application No. 60/802,110, filed on May 22, 2006.

(51) Int. Cl. G06Q 40/00

(52) U.S. Cl. 705/37

(57) ABSTRACT

Methods and systems for trading financial products such as loans over a network such as the Internet that includes receiving information relating to the financial product offered for sale on behalf of a seller, making the information relating to the financial product available over the network, receiving a bid from a buyer, wherein the bid comprises at least an amount offered to purchase the loan, and performing due diligence on the financial product. Methods and systems also include storing the information in a data storage medium at a central location to be searched by potential buyers, the information being accessible via, for example, the Internet.

### RELATED APPLICATIONS

This application claims the benefit of U.S. Provisional Patent Application No. 60/996,949 titled METHODS AND SYSTEMS FOR NETWORK LOAN MARKETING filed on Dec. 12, 2007, and of U.S. Provisional Patent Application No. 60/996,975 titled VENDOR ASSURANCE filed Dec. 12, 2008. This application is also a continuation-in part of U.S. application Ser. No. 11/802,308 titled METHOD AND SYSTEM FOR MORTGAGE EXCHANGE filed on May 22, 2007, and claiming the benefit of U.S. Provisional Application No. 60/802,110 filed on May 22, 2006. The entirety of each of the aforementioned patent applications is hereby incorporated reference herein.

### BACKGROUND OF THE INVENTION

1. Field of Invention

Aspects of the present invention relate to the marketing of specific loans. More particularly, variations of this invention relate to a clearinghouse for the exchange of loans, such as commercial or residential mortgages.

2. Description of Related Art

Recently, institutions having loans on their balance sheets have moved from a “hold to maturity” philosophy, i.e., holding loans until they are paid off, to a proactive portfolio management model. Larger, more sophisticated institutions first adopted the proactive portfolio management model, and the popularity of this model has migrated down to smaller institutions. Managers of such proactive portfolios are often concerned with a number of issues, including liquidity, capacity, exposure, and credit risk. Managers are increasingly recognizing the emerging secondary whole loan market as the appropriate mechanism for managing these concerns. On the secondary whole loan market, investors can buy and sell loans, thus spreading a portion of the risk involved in managing the loans. However, the secondary whole loan market generally lacks necessary efficiencies and liquidity. Trading and originating commercial loans is currently handled in a costly, labor-intensive, and time-consuming manner. The lack of a centralized clearing mechanism for commercial loans hampers both sellers and buyers of commercial loans.

Furthermore, the amount of buybacks and repurchases of loans has been steadily increasing (particularly recently with the economic situation). As a result, the “scratch and dent” share of loans on the market has considerably increased. Also, the loan volume has been steadily increasing in the past few years, along with the loan volume of non-prime, sub-prime and Alternative A-paper (Alt-A) loans.

### SUMMARY OF THE INVENTION

Managers and other sellers of commercial loans currently face a number of obstacles. For example, the commercial loan market is fragmented and has no central clearing mechanism, making it difficult to locate the best buyer for a given loan. Frequently, managers are unable to inform more than a few buyers about a commercial loan opportunity. Such limited opportunities limit the efficiency with which a transaction can occur, and can result in a seller not achieving the best price or terms for the sale. In addition, lack of historical transaction data can impede the ability of parties to a transaction to price assets quickly and accurately. This limitation can make the analysis of a sell decision inefficient and time-consuming.

There remains, therefore, in the related art a need for a forum, such as, a web-based “mega mall” of closed residential loans, facilitating access to key information such as credit score, Fair Isaac Corporation (FICO) score, and the like. Also, there is a need in the related art to provide traders with the ability and tools to hedge and fulfill commitments via a one-stop warehouse, reducing the need to shop loans to multiple investors, and/or to provide a source of nationwide loans for buyers to shop for loans that meet financial needs. These innovations may thus result in an efficient and rapid execution of loan transaction sales.

In light of the above described problems and shortcomings, various exemplary aspects of the current invention provide systems and methods for trading loans, such as commercial or residential loans, over a computer network. According to various exemplary aspects, the systems and methods include receiving information relating to a loan offered for sale from a client over the network on behalf of a seller, making the information relating to the loan available over the network, and receiving a bid from a buyer, wherein the bid comprises at least an amount offered to purchase the loan.

Various exemplary aspects of the current invention also provide methods and systems for trading loans over a computer network that includes a processor, a user interface functioning via the processor, and a repository accessible by the processor, wherein information relating to a loan offered for sale is received from a client over the network on behalf of a seller, the information relating to the loan is made available over the network, and a bid is received from a buyer, wherein the bid comprises at least an amount offered to purchase the loan.

Additional advantages and novel features of aspects of the invention will be set forth in part in the description that follows, and in part will become more apparent to those skilled in the art upon examination of the following or upon learning by practice of the invention.

### BRIEF DESCRIPTION OF THE DRAWINGS

Various exemplary aspects of the systems and methods will be described in detail, with reference to the following figures, wherein:

FIG. 1 is a exemplary flow chart illustrating a method of trading loans over a computer network, according to various exemplary aspects;

FIG. 2 is an illustration of the life cycle of a loan;

FIG. 3 is an illustration of a system for trading loans over a computer network, according to various exemplary aspects;

FIG. 4 presents an exemplary system diagram of various hardware components and other features, for use in accordance with an aspect of the present invention; and

FIG. 5 is a block diagram of various exemplary system components, in accordance with an aspect of the present invention.

### DETAILED DESCRIPTION OF PREFERRED ASPECTS

These and other features and advantages of this invention are described in, or are apparent from, the following detailed description of various exemplary aspects of the current invention.

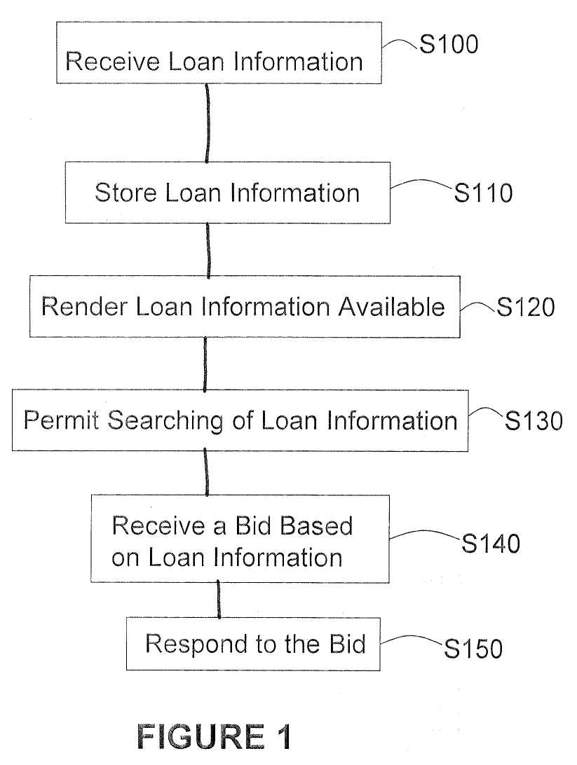

FIG. 1 is a flow chart illustrating a exemplary method of trading loans over a computer network, according to various exemplary aspects. In FIG. 1, the method starts at S100, where information relating to a loan, such as a conventional loan, or an underperforming loan a (e.g., “scratch and dent” loan), is received. According to various exemplary aspects, the financial information may be provided by a seller, and may include relevant financial information about the loan such as loan-to-value information, Fair Isaac Corporation (FICO) score, combined loan-to-value information, and the like. Such financial information typically allows an investor to estimate the value of the loan and to determine the business-worthiness of the loan. Furthermore, the loan may be an individual loan, a pool of individual loans, a pool of individual “scratch and dent” loans, a residential or commercial loan, a defaulted loan, a forward commitment loan, a credit, a residential lien, a commercial loan, or any other similar product, for example.

Next, the method continues to S110, where, according to various exemplary aspects, the financial information may be stored in memory or in a data repository, for example. The received information about a number of loans may be organized within the memory or data repository in order to be searchable via, for example, a Boolean search or other type of search. The information may be stored at a central location. It should be noted that “central location” should not be limited to a central physical location, although it could be a central physical location. The location, according to various aspects of the current invention, is “central” in that is provides a single central storage location for the data, which may, for example, be disposed in several interconnected physical locations (e.g., servers). The stored information about the various loans may be organized in a way that facilitates searching of relevant information in an efficient manner, for example, so that third parties that are not loan specialists can obtain a reasonable idea of the quality of the loan on the basis of the accessed financial information about the loan. Next, the method continues to S120.

During S120, the financial information about the loan is made available over a network, such as the Internet. According to various exemplary aspects, the financial information may be made available to potential buyers or bidders on a centralized server accessible over the Internet via, for example, a website. Thus, for example, potential buyers or bidders may have access to relevant information about the loan that may help the buyers or bidders determine whether they are likely to bid on the loan and at what price. On the side of the potential buyers or bidders, an interface may be created, such as, a Graphic User Interface (GUI), that may allow potential buyers or bidders to access the loan information.

Next, the method continues to S130, where the loan information is permitted to be searched by third parties. Accordingly, third parties may, for example, enter preferred characteristics about the type of loans they may be interested in purchasing, thereby increasing the efficiency of the searching process. Thus, the information on the loans may be organized in the memory or database in such a way as to allow a potential buyer to browse the available loans by using, for example, a search engine and/or a method of search, such as a Boolean search. According to various aspects, the financial information on one or more of the loans offered for sale may be updated regularly in order to reflect, for example, the latest changes in the parameters of the loans, changes in the interest rates, and the like. According to various exemplary aspects, potential buyers may also download the information about the loans offered for sale on, for example, a computer. Next, the method continues to S140.

During S140, a bid may be received from a potential buyer. According to various exemplary aspects, the bid may be received on the basis of the loan information that was rendered accessible to potential buyers and bidders. According to various exemplary aspects, the bid may be received via a network, such as the Internet. Once the bid is received, the seller may directly access the bid, or the bid may be forwarded to the seller. Next, the method continues to S150, where the seller may determine whether to accept the bid and sell the loan to the buyer. According to various exemplary aspects, the seller may also make a counter-offer to the bidder, or suggest other parameters for completing the transaction. The seller may negotiate with the bidder via the network and a website used to post the information about the loans and to receive the various bids, and may negotiate with the bidder directly outside the network. If both bidder and seller decide to negotiate directly, then they may use more traditional negotiating techniques, such as meetings, telephone conferences, and the like.

It should be noted that once a bid is received from a buyer and the buyer and bidder agree on terms, due diligence may be performed on the loan that is the subject of the bid. According to various exemplary aspects, due diligence may also be performed on one or more loans before a bid is received from a potential buyer, or even before making the loan available over the network to potential buyers or bidders.

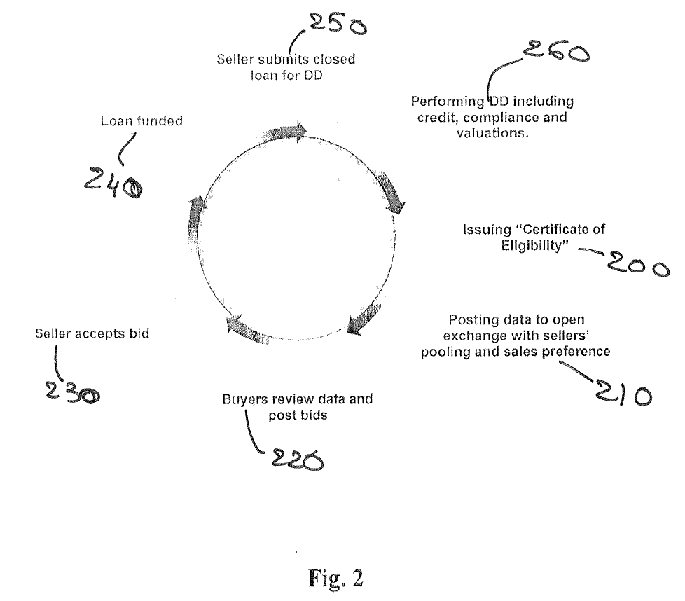

FIG. 2 is an illustration of the life cycle of a loan, as relating to certain exemplary functions in accordance with various aspects of the current invention. In FIG. 2, the loan may first be examined, and a Certificate of Eligibility 200 may be issued. Also, loan information may be posted via a posting 210 to start the exchange with potential sellers. For example, the exchange may be with sellers' pooling and sales preferences. According to various aspects of the current invention, potential buyers 220 may review the financial data and may post one or more bids, if the financial data satisfies the potential buyers' requirements, where the bids are accessible to the seller. Once a buyer posts a bid, the seller may make a determination 230 about whether to accept the bid. According to various exemplary aspects, the seller may post some financial information on a loan or other financial product on a server via a website. The financial information posted by the seller may not be complete financial information, for example, but may include enough information to allow a potential bidder to reach a decision on whether to bid on the loan.

According to various aspects of the current invention, the potential buyer or bidder may review the financial information and may also post a bid on the website. Once the seller accepts the bid, all information about the loan may then be posted on the website in its entirety for review, or provided directly to the bidder. According to various aspects of the current invention, the loan may then be funded 240. The loan may be funded by the buyer, for example. Once the loan is funded by the buyer, the seller may perform a submission 250 of the loan for due diligence. Subsequently, due diligence 260 may be performed on the closed loan. According to various exemplary aspects of the current invention, due diligence may include one or more of a credit check, compliance verification, valuation and/or other procedures.

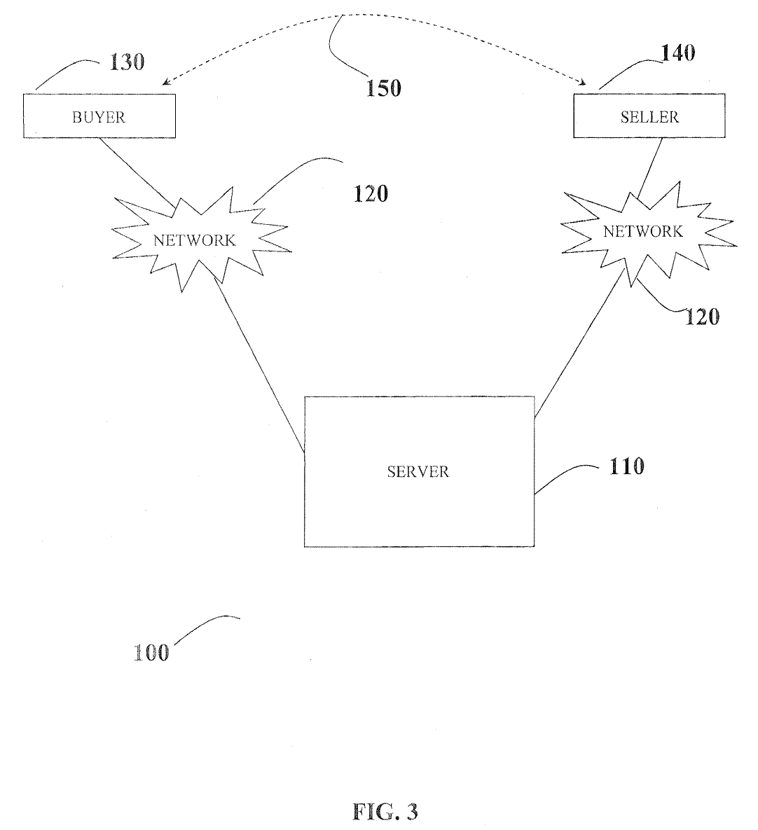

FIG. 3 is an illustration of a system 100 for trading loans over a computer network, according to various exemplary aspects. In FIG. 3, the seller 140 of a financial product, such as a loan, may post information relating to the financial product on a server 110, where the relevant information about the financial product may be stored. The seller 140 may also post the information relating to the loan on the server 110 via a network 120, such as the Internet. The financial information about one or more of the loans offered for sale by the seller 140 may be updated regularly in order to reflect, for example, the latest changes in the parameters of the loans, changes in the interest rates, and the like. According to various aspects of the current invention, the financial information may be updated by the seller 140 or by a party acting on behalf of the seller 140. Also, the financial information relating to the loan that is posted on the server 110 may be made available to third parties via a website. Once the information from the seller is posted on the server 110, a bidder or potential buyer 130, who may have access to the website 110 via an interface (e.g., a GUI), may review the posted financial information. Based on the financial information about the loan, the potential buyer may determine whether to bid on the loan.

With respect to the potential buyer or bidder 130, an interface may be created with a search engine that allows the potential buyer or bidder 130 to, for example, enter preferred characteristics about the type of loans that the buyer/bidder 130 is interested in purchasing. Such a search engine may increase the efficiency of the searching process, among other things. According to various aspects of the current invention, the buyer/bidder 130 may have access to the financial information stored on the server 110 via a network, such as the Internet. Thus, the information about the loans may be organized in the system in such a way as to allow the potential buyer 130 to browse the available loans by using a search engine and a method of search, such as a Boolean search. According to various exemplary aspects, the potential buyer 130 may review the financial information posted on the server 110 over the network 120, and may also download the financial information stored on the server 110 on a memory of the buyer/bidder 130, such as a computer or database or other data repository. Once the potential buyer 130 determines that the financial information warrants a bid, the potential buyer 130 may bid for the loan. According to various exemplary aspects, the potential buyer 130 may post a bid on the server 110, or may post the bid on the server 110 via the network 120. Subsequently, the seller 140 may determine whether to accept the bid for the posted loan or whether to reject it. According to various exemplary aspects, the seller 140 may also make a counter-offer to the bidder or buyer 130, or suggest other parameters for completing the transaction. The seller 140 may negotiate with the bidder/buyer 130 either via the network and the website used to post the information about the loans and to receive the various bids, or directly with the bidder 130 outside the network via a direct transaction 150. The decision of the seller 140 may also be posted on the server 110 via the network 120.

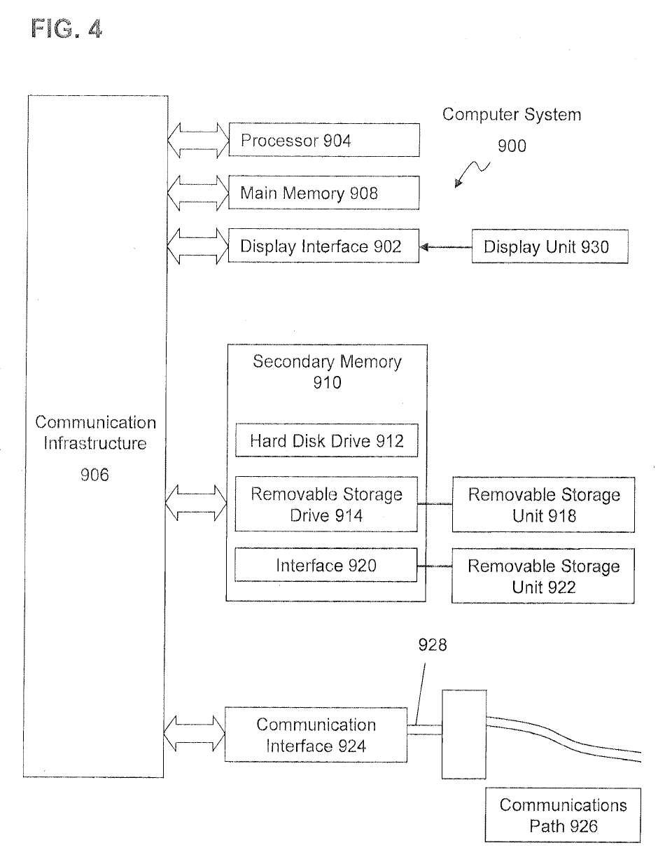

FIG. 4 presents an exemplary system diagram of various hardware components and other features, for use in accordance with an aspect of the present invention. Aspects of the present invention may be implemented using hardware, software, or a combination thereof and may be implemented in one or more computer systems or other processing systems. In one variation, aspects of the invention are directed toward one or more computer systems capable of carrying out the functionality described herein. An example of such a computer system 900 is shown in FIG. 4.

Computer system 900 includes one or more processors, such as processor 904. The processor 904 is connected to a communication infrastructure 906 (e.g., a communications bus, cross-over bar, or network). Various software aspects are described in terms of this exemplary computer system. After reading this description, it will become apparent to a person skilled in the relevant art(s) how to implement aspects of the invention using other computer systems and/or architectures.

Computer system 900 can include a display interface 902 that forwards graphics, text, and other data from the communication infrastructure 906 (or from a frame buffer not shown) for display on a display unit 930. Computer system 900 also includes a main memory 908, preferably random access memory (RAM), and may also include a secondary memory 910. The secondary memory 910 may include, for example, a hard disk drive 912 and/or a removable storage drive 914, representing a floppy disk drive, a magnetic tape drive, an optical disk drive, etc. The removable storage drive 914 reads from and/or writes to a removable storage unit 918 in a well-known manner. Removable storage unit 918, represents a floppy disk, magnetic tape, optical disk, etc., which is read by and written to removable storage drive 914. As will be appreciated, the removable storage unit 918 includes a computer usable storage medium having stored therein computer software and/or data. In alternative aspects, secondary memory 910 may include other similar devices for allowing computer programs or other instructions to be loaded into computer system 900. Such devices may include, for example, a removable storage unit 922 and an interface 920. Examples of such may include a program cartridge and cartridge interface (such as that found in video game devices), a removable memory chip (such as an erasable programmable read only memory (EPROM), or programmable read only memory (PROM)) and associated socket, and other removable storage units 922 and interfaces 920, which allow software and data to be transferred from the removable storage unit 922 to computer system 900.

Computer system 900 may also include a communications interface 924. Communications interface 924 allows software and data to be transferred between computer system 900 and external devices. Examples of communications interface 924 may include a modem, a network interface (such as an Ethernet card), a communications port, a Personal Computer Memory Card International Association (PCMCIA) slot and card, etc. Software and data transferred via communications interface 924 are in the form of signals 928, which may be electronic, electromagnetic, optical or other signals capable of being received by communications interface 924. These signals 928 are provided to communications interface 924 via a communications path (e.g., channel) 926. This path 926 carries signals 928 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 980, a hard disk installed in hard disk drive 970, and signals 928. These computer program products provide software to the computer system 900. The invention is directed to such computer program products.

Computer programs (also referred to as computer control logic) are stored in main memory 908 and/or secondary memory 910. Computer programs may also be received via communications interface 924. Such computer programs, when executed, enable the computer system 900 to perform the features of the present invention, as discussed herein. In particular, the computer programs, when executed, enable the processor 910 to perform the features of the present invention. Accordingly, such computer programs represent controllers of the computer system 900.

In an aspect where the invention is implemented using software, the software may be stored in a computer program product and loaded into computer system 900 using removable storage drive 914, hard drive 912, or communications interface 920. The control logic (software), when executed by the processor 904, causes the processor 904 to perform the functions of the invention as described herein. In another aspect, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another aspect, the invention is implemented using a combination of both hardware and software.

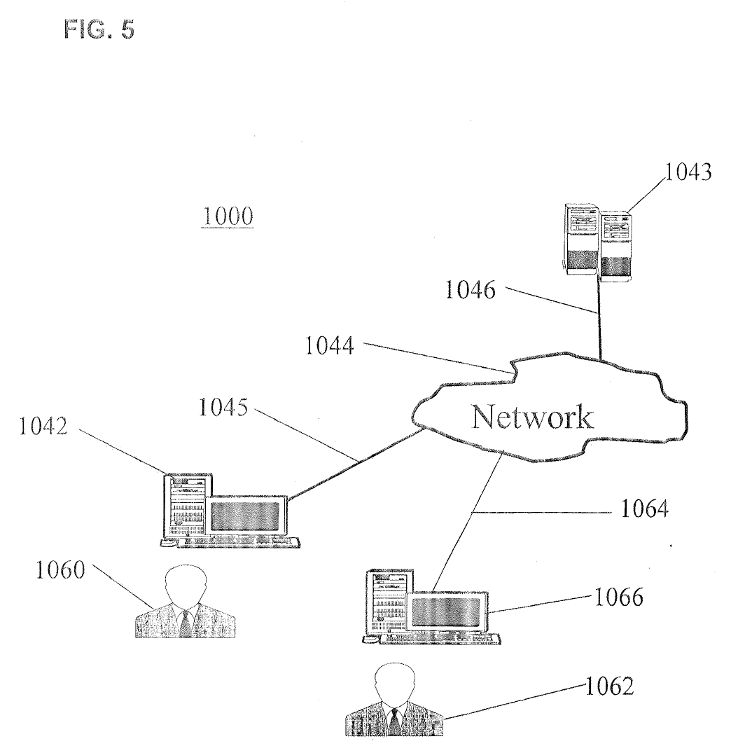

FIG. 5 is a block diagram of various exemplary system components, in accordance with an aspect of the present invention. The communication system 1000 includes one or more accessors 1060, 1062 (also referred to interchangeably herein as one or more “users”) and one or more terminals 1042, 1066. In one aspect, data for use in accordance with the present invention is, for example, input and/or accessed by accessors 1060, 1064 via terminals 1042, 1066, such as personal computers (PCs), minicomputers, mainframe computers, microcomputers, telephonic devices, or wireless devices, such as personal digital assistants (“PDAs”) or a hand-held wireless devices coupled to a server 1043, such as a PC, minicomputer, mainframe computer, microcomputer, or other device having a processor and a repository for data and/or connection to a repository for data, via, for example, a network 1044, such as the Internet or an intranet, and couplings 1045, 1046, 1064. The couplings 1045, 1046, 1064 include, for example, wired, wireless, or fiberoptic links. In another variation, the method and system in accordance with aspects of the present invention operate in a stand-alone environment, such as on a single terminal.

While aspects of this invention have been described in conjunction with the exemplary features outlined above, various alternatives, modifications, variations, improvements, and/or substantial equivalents, whether known or that are or may be presently unforeseen, may become apparent to those having at least ordinary skill in the art. Accordingly, the exemplary aspects of the invention, as set forth above, are intended to be illustrative, not limiting, Various changes may be made without departing from the spirit and scope of the invention. Therefore, aspects of the invention are intended to embrace all known or later-developed alternatives, modifications, variations, improvements, and/or substantial equivalents.

What is claimed is:

1. A method of trading a financial product over a computer network, the method comprising:
receiving information relating to the financial product offered for sale on behalf of a seller;
storing the information in a data storage medium at a central location;
making the information available from the central location to one or more third parties via the computer network;
receiving, via the computer network, a bid from a potential buyer, wherein the bid comprises at least an amount offered to purchase the financial product;
providing a response to the bid; and
performing due diligence on the financial product;
wherein ownership of the financial product is transferred based on the response.

2. The method of claim 1, wherein the financial product is a loan.

3. The method of claim 1, further comprising making due diligence information available to the potential buyer.

4. The method of claim 1, wherein the information relating to the financial product comprises at least one of loan-to-value, FICO score and combined loan-to-value.

5. The method of claim 1, wherein the computer network comprises the Internet.

6. The method of claim 1, wherein the information relating to the financial product stored in the data storage medium is searchable by the one or more third parties via a search engine.

7. The method of claim 1, wherein the financial product is at least one of a “scratch and dent” loan, a residential loan, a defaulted loan, a forward commitment deficiency, a credit, a residential lien and a commercial loan.

8. A system for trading a financial product over a computer network, the system comprising:
a processor;
a user interface functioning via the processor; and
a repository accessible by the processor; wherein
information relating to a financial product offered for sale is received on behalf of a seller;
the information relating to the financial product is stored in a data storage medium at a central location;
the information is made available from the central location to one or more third parties via the computer network;
a bid is received from a buyer via the computer network, wherein the bid comprises at least an amount offered to purchase the financial product;
a response to the bid is provided; and
due diligence on the financial product is performed;
wherein ownership of the financial product is transferred based on the response.

9. The system of claim 8, wherein the financial product is a loan.

10. The system of claim 8, wherein the information relating to the financial product comprises at least one of loan-to-value, FICO score and combined loan-to-value.

11. The system of claim 8, wherein the information relating to the financial product stored in the data storage medium is searchable by the one or more third parties via a search engine.

12. The system of claim 8, wherein the financial product is at least one of a “scratch and dent” loan, a residential loan, a defaulted loan, a forward commitment deficiency, a credit, a residential lien and a commercial loan, an individual loan and a pool of loans.

13. The system of claim 8, wherein the computer network comprises the Internet.

14. The system of claim 8, wherein the processor is housed on a terminal.

15. The system of claim 14, wherein the terminal is selected from a group consisting of a personal computer, a minicomputer, a main frame computer, a microcomputer, a hand held device, and a telephonic device.

16. The system of claim 8, wherein the processor is housed on a server.

17. The system of claim 16, wherein the server is selected from a group consisting of a personal computer, a minicomputer, a microcomputer, and a main frame computer.

18. A computer program product comprising a computer usable medium having control logic stored therein for causing a computer to trade a financial product over a computer network, the control logic comprising:
first computer readable program code means for receiving information relating to the financial product offered for sale on behalf of a seller;
second computer readable program code means for storing the information in a data storage medium at a central location;
third computer readable program code means for making the information available over the computer network from the central location to one or more third parties;
fourth computer readable program code means for receiving a bid from a potential buyer, wherein the bid comprises at least an amount offered to purchase the loan;
fifth computer readable program code means for providing a response to the bid over the computer network; and
sixth computer readable program code means for performing due diligence on the financial product;
wherein ownership of the financial product is transferred based on the response.
